(19) United States
(12) Patent Application Publication
(10) Pub. No.: US 2009/0224053 A1
(43) Pub. Date: Sep. 10, 2009

(54) COMPUTER STORAGE LIBRARY BARCODE READER

(75) Inventors: John A. Barkley, Longmont, CO (US); Jeffrey P. Davies, Louisville, CO (US)

Correspondence Address: NIXON & VANDERHYE, PC, 901 NORTH GLEBE ROAD, 11TH FLOOR, ARLINGTON, VA, 22203, US

(73) Assignee: TANDBERG DATA CORPORATION, Boulder, CO (US)

(21) Appl. No.: 12/362,559

(22) Filed: Jan. 30, 2009

Related U.S. Application Data
(60) Provisional application No. 61/024,795, filed on Jan. 30, 2008.

(51) Int. Cl. G06K 7/10

(52) U.S. Cl. 235/462.42

(57) ABSTRACT

A barcode reader comprises a housing (1); plural light emitting elements (3) mounted on the housing (1) for illuminating a barcode (L) in a target area; and optical elements (5, 7) mounted on the housing (1) for receiving light reflected from the barcode (L). The plural light emitting elements (3) are mounted on the housing (1) whereby illumination axes of the plural light emitting elements (3) form respective non-right angles to a plane of the barcode (L) and whereby illumination footprints of the plural light emitting elements have an elliptical shape.

This application claims the benefit and priority of United States Provisional Patent Application 61/024,795, filed Jan. 30, 2008, the entire contents of which is incorporated by reference in its entirety.

### BACKGROUND

I. Technical Field

The present invention pertains to reading information by optical means, and particularly, by optical illumination using a CCD based barcode reader.

II. Related Art and Other Considerations

CCD barcode readers use an array of tiny light sensors lined up in the head of the barcode reader. Voltage waveform corresponding to the bars and spaces of the bar code is generated and sent to a decoder, which decodes the data and sends it to a computer.

Although the advantages associated with light emitting diodes (LEDs) when used in barcode equipment are well known, CCD based barcode readers used in computer storage libraries have typically experienced problems reading reliably, when glossy finish barcode labels are used. The source of the reduced reading reliability is mainly due to reflections from the white areas of the glossy label. Some of these reflections are imaged in the dark areas of the CCD array image, thereby reducing the image contrast, causing localized reductions in the dynamic range of the CCD signal and reduced reading reliability. This problem is significant enough that some computer storage library manufacturers do not support the use of glossy labels in their products.

However, glossy finish barcode labels are sometimes preferable because they are more durable. Efforts at improvements in reading reliability usually involve arranging the optical axis and the illumination axis so they are not normal to the barcode label when these axes are viewed in a vertical plane. This geometry decreases the amount of reflected light from the label that is directed back to the barcode reader and its CCD unit.

Packaging constraints usually limit the amount of the off-axis deviation for the illumination light to a few degrees. This limited angular change is not effective because the LED illumination has a general shape of a cone with a half angle much greater than the angular change in the optical and illumination axes, therefore there is significant reflected light that reaches the CCD array image. In order to overcome this problem, an illumination diffuser 5 (see, for example, FIG. 1) located in the optical path of the illumination light may be used to reduce the emission hot spots normally seen with LED's. FIGS. 1, 2, 3, and 4 show CCD based barcode readers incorporating the conventional illumination orientation.

### BRIEF SUMMARY

A barcode reader comprises a housing; plural light emitting elements mounted on the housing for illuminating a barcode in a target area; and optical elements mounted on the housing for receiving light reflected from the barcode. The plural light emitting elements are mounted on the housing whereby illumination axes of the plural light emitting elements form respective non-right angles to a plane of the barcode and whereby illumination footprints of the plural light emitting elements have an elliptical shape.

The optical elements mounted to the housing further comprise a lens positioned to receive and focus reflected light from the barcode; a charged coupled device (CCD); and, a mirror configured to direct the focus reflected light to the charged coupled device (CCD). Preferably the plural light emitting elements are centered about the lens.

The plural light emitting elements are mounted so that the illumination footprints of the plural light emitting elements overlap.

In an example embodiment, the plural light emitting elements are each mounted in a respective compartment situated on an underside of a top panel of the housing. Each compartment is separated by partitions.

Angular mounting of the plural light emitting elements obviates need of a diffuser in an optical path between the plural light emitting elements and the barcode.

Thus, a CCD-based barcode reader is provided with increased illumination angles to the barcode label. The increase in the angle of incidence for the illumination light when viewed in a horizontal plane results in reduced light directly reflected back into the CCD array, thus yielding higher image contrast at the light sensor.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is an Isometric View of a Low Illumination Angle (Vertical) type of Barcode Reader.

FIG. 2 is an End View of the Low Illumination Angle (Vertical) type of Barcode Reader of FIG. 1.

FIG. 3 is a Cross-section View of the Low Illumination Angle (Vertical) type of Barcode Reader of FIG. 1.

FIG. 4 is a Top View of the Low Illumination Angle (Vertical) type of Barcode Reader of FIG. 1.

FIG. 5 is an Isometric View of an Increased Illumination Angle (Horizontal) type of Barcode Reader according to an example embodiment.

FIG. 6 is an End View of the Increased Illumination Angle (Horizontal) type of Barcode Reader of FIG. 5.

FIG. 7 is a Cross-section View of the Increased Illumination Angle (Horizontal) type of Barcode Reader of FIG. 5.

FIG. 8 is a Top View of the Increased Illumination Angle (Horizontal) type of Barcode Reader of FIG. 5.

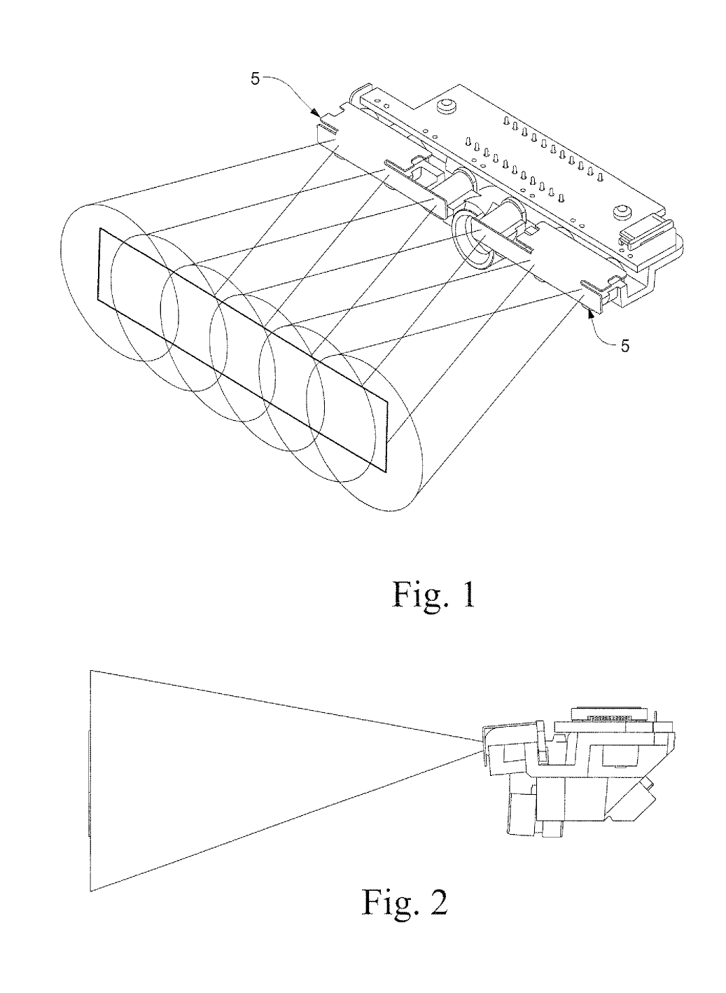

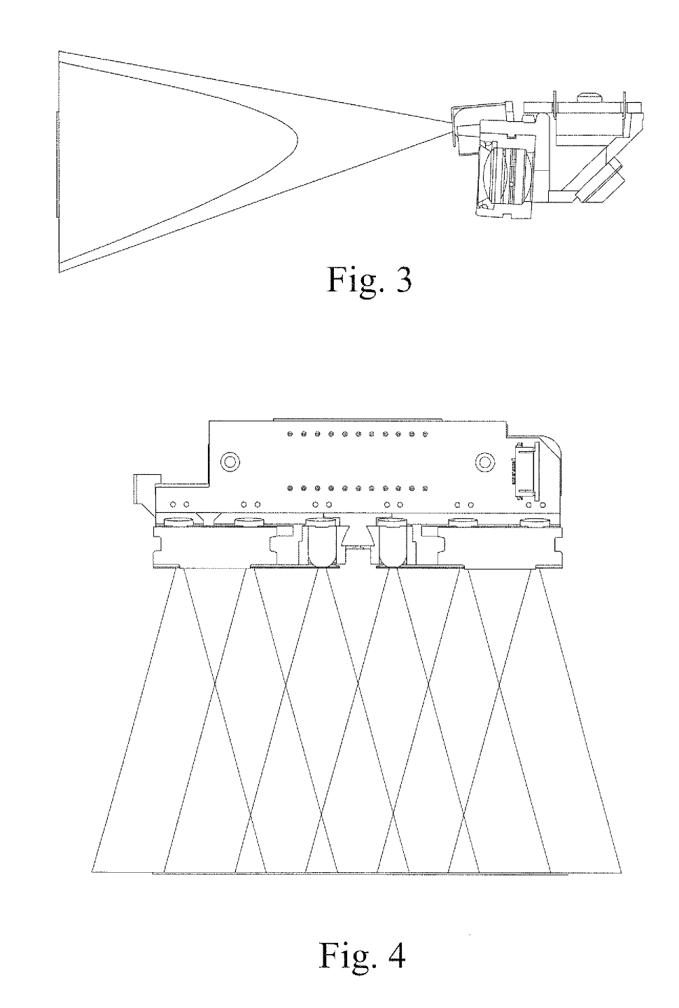

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

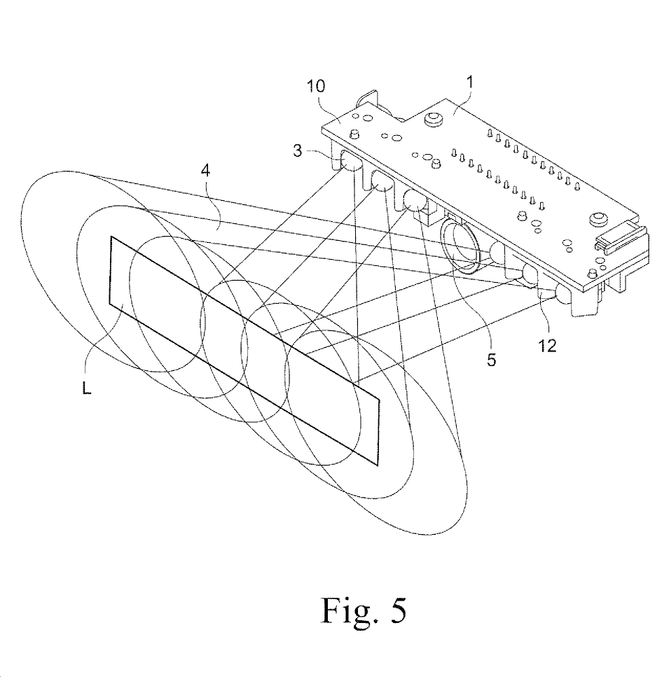

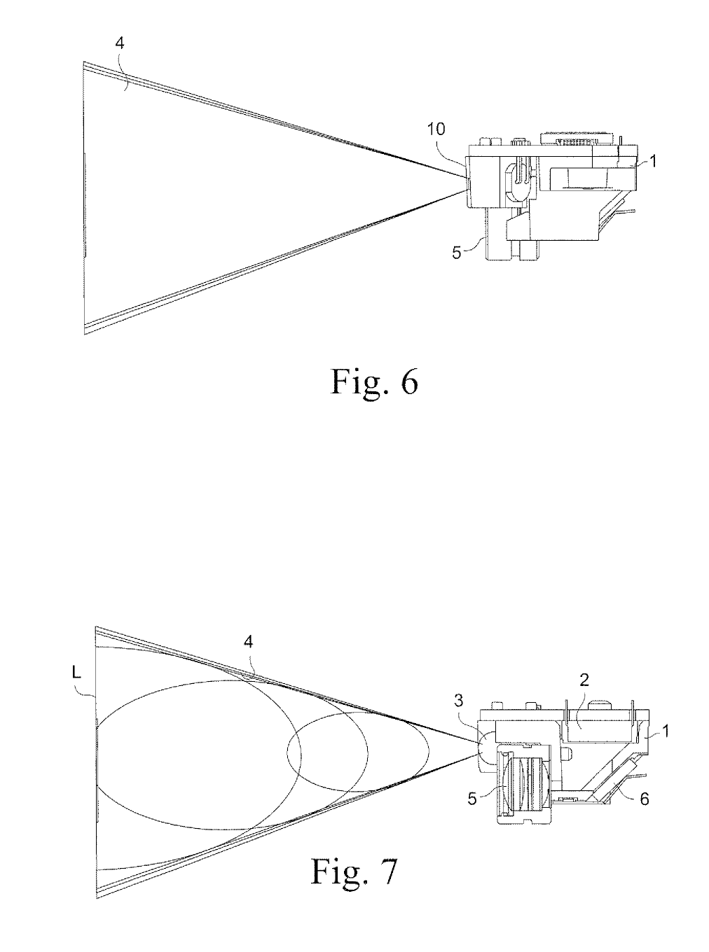

FIG. 5-FIG. 8 show an example, non-limiting embodiment of a barcode reader illumination arrangement. The barcode reader of the example embodiment comprises barcode reader housing 1; CCD array 2; an array of illumination LEDs 3; lens 5; and mirror 6. In FIG. 5-FIG. 8, reference numeral 4 depicts an LED emission pattern from the array of LEDs 3.

In the example barcode reader, six LEDs 3 are provided. In other embodiments, a greater or lesser number of LEDs 3 can be provided. The six LEDs 3 are mounted in stalls or compartments situated on an underside of top panel 10 of housing 1. The stalls or compartments are, in the example embodiment, separated by partitions 12. Lens 5 is situated substantially in the center of the array of LEDs 3, e.g., with an equal number of LEDs 3 on a right side and on a left side. That is, the plural light emitting elements (LEDs) 3 are centered about the lens.

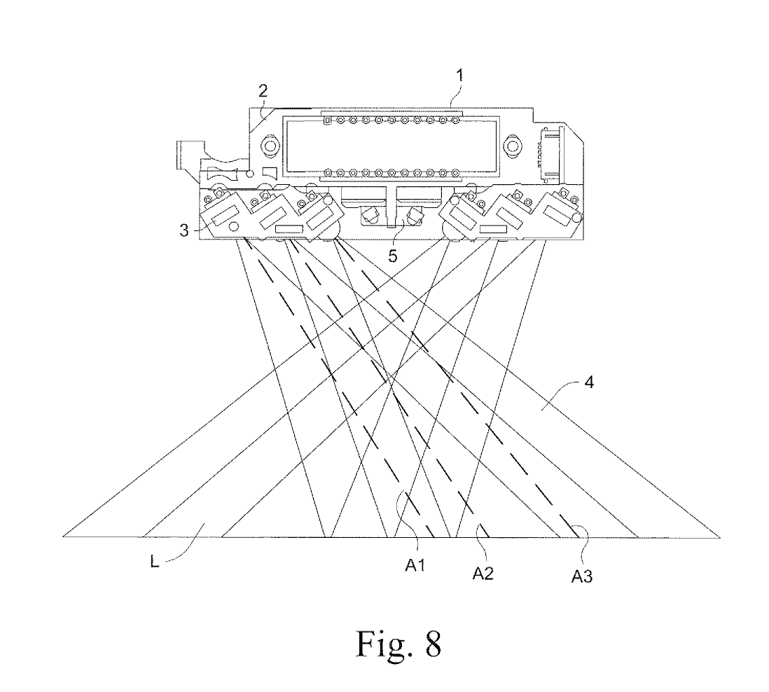

The barcode reader according to the present technology provides plural LEDs 3 and arranges illumination axes of the plural LEDs at their respective (non-right) angles to the barcode label L when viewed in a horizontal plane (see FIG. 8). The illumination axes for three adjacent LEDs 3 are depicted (by broken lines) in FIG. 8, as well as their respective angles A1, A2, and A3 of incidence to barcode label L.

This LED orientation scheme overcomes such issues as packaging constraints, and allows much greater angles between the illumination axis and the glossy barcode label, which greatly reduces the reflected light reaching the CCD array image. Therefore, the CCD image contrast is higher and the barcode read reliability is improved.

As can be seen, for example, in FIG. 5, the LEDs are arranged to illuminate the barcode label in a horizontal plane. The array of LEDs 3 emits light 4 that exits the barcode reader housing 1 and illuminates the target. Light reflected from the target is incident onto the reader and is imaged onto a CCD array 2 via optical elements, including lens 5 and mirror 7.

Due to the increased illumination angle, the normally round illumination footprint is changed into an ellipse, thus increasing the overlap between the illumination footprints from adjacent LEDs. That is, as shown for example in FIG. 5 and FIG. 7, illumination footprints of the plural light emitting elements have an elliptical shape. In this way, the illumination profile at the barcode label becomes more uniform. Consequently, a separate diffuser is not needed to be included in the optical path to more uniformly distribute the light within the target area.

FIG. 8 shows a top view of the barcode reader. A plurality of light emitting diodes 3 are mounted in the same plane, for providing coplanar illumination. The light from the light emitting diodes is projected onto the target region (occupied, e.g., by the barcode label L). Light is reflected from the target such that it is received by the barcode reader, but with decreased direct reflections.

Thus, a CCD based barcode reader with improved image contrast ratio at the light sensor is provided. Illumination light when viewed in a horizontal plane subtends larger angles of incidence to the barcode label. Light reflected from the target directly back into the CCD array is decreased, resulting in increased reading reliability

The barcode reader as described herein can have various employments, such as (for example) in the cartridge libraries described by one or more of the following (all of which were filed May 11, 2007 and all of which are incorporated by reference herein in their entireties):

U.S. patent application Ser. No. 11/747,311, entitled “METHOD AND APPARATUS FOR POSITIONING DRIVES IN CARTRIDGE LIBRARY”;

U.S. patent application Ser. No. 11/747,295, entitled “TRANSPORT METHOD AND APPARATUS FOR CARTRIDGE LIBRARY”;

U.S. patent application Ser. No. 11/747,305, entitled “ENTRY/EXIT PORT METHOD AND APPARATUS FOR CARTRIDGE LIBRARY”;

U.S. patent application Ser. No. 11/747,315, entitled “CARTRIDGE ENGAGEMENT APPARATUS AND METHOD FOR CARTRIDGE LIBRARY”;

U.S. patent application Ser. No. 11/747,321, entitled “MULTI-DIMENSIONAL TRANSPORT METHOD AND APPARATUS FOR CARTRIDGE LIBRARY”.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A barcode reader comprising:
a housing;
plural light emitting elements mounted on the housing for illuminating a barcode in a target area;
optical elements mounted on the housing for receiving light reflected from the barcode;
wherein the plural light emitting elements are mounted on the housing whereby illumination axes of the plural light emitting elements form respective non-right angles to a plane of the barcode and whereby illumination footprints of the plural light emitting elements have an elliptical shape.

2. The apparatus of claim 1, wherein the illumination footprints of the plural light emitting elements overlap.

3. The apparatus of claim 1, wherein the optical elements comprise a lens, and wherein the plural light emitting elements are centered about the lens.

4. The apparatus of claim 3, further six plural light emitting elements centered about the lens.

5. The apparatus of claim 1, wherein the plural light emitting elements are each mounted in a respective compartment situated on an underside of a top panel of the housing.

6. The apparatus of claim 5, wherein each compartment is separated by partitions.

7. The apparatus of claim 1, wherein angular mounting of the plural light emitting elements obviates need of a diffuser in an optical path between the plural light emitting elements and the barcode.

8. The apparatus of claim 1, wherein the optical elements mounted to the housing further comprise:
a lens positioned to receive and focus reflected light from the barcode;
a mirror configured to direct focused reflected light to a charged coupled device (CCD).
